(19) United States
(12) Patent Application Publication
(10) Pub. No.: US 2014/0071053 A1
(43) Pub. Date: Mar. 13, 2014

(54) ELECTRONIC APPARATUS, NON-TRANSITORY COMPUTER-READABLE STORAGE MEDIUM STORING COMPUTER-EXECUTABLE INSTRUCTIONS, AND A METHOD FOR CONTROLLING AN EXTERNAL DEVICE

(71) Applicant: Kabushiki Kaisha Toshiba, Tokyo (JP)

(72) Inventors: Junichi Nagata, Tsuragashima-shi (JP); Minoru Ohta, Yokohama-shi (JP)

(73) Assignee: Kabushiki Kaisha Toshiba, Tokyo (JP)

(21) Appl. No.: 13/973,832

(22) Filed: Aug. 22, 2013

Related U.S. Application Data
(63) Continuation of application No. PCT/JP2013/057926, filed on Mar. 13, 2013.

(30) Foreign Application Priority Data
Sep. 7, 2012 (JP) 2012-197307

(51) Int. Cl. G06F 3/02

(52) U.S. Cl. CPC G06F 3/02
USPC 345/168

(57) ABSTRACT

According to one embodiment, an electronic apparatus for controlling an external device comprises a communication module, an operation module, a recognition module, and a controller. The communication module is configured to communicate with the external device. The operation module is configured to display a keyboard screen of one of a plurality of types on a display, and transmit a signal to the external device based on an operation on the keyboard screen. The recognition module is configured to recognize an attribute of an input space which is selected in the external device. The controller is configured to perform control to switch a type of the keyboard screen displayed on the display based on the attribute recognized by the recognition module.

### CROSS REFERENCE TO RELATED APPLICATIONS

This application is a Continuation Application of PCT Application No. PCT/JP2013/057926, filed Mar. 13, 2013 and based upon and claiming the benefit of priority from Japanese Patent Application No. 2012-197307, filed Sep. 7, 2012, the entire contents of all of which are incorporated herein by reference.

### FIELD

Embodiments described herein relate generally to an electronic apparatus, a non-transitory computer-readable storage medium storing computer-executable instructions, and a method for controlling an external device by an electronic apparatus.

### BACKGROUND

Electronic apparatuses which can play back image contents such as movies, television programs, and games have become widespread.

In addition, electronic apparatuses, which include displays that display various information items and touch sensors that generate signals in response to user's operation, have been put to practical use. The electronic apparatus transmits a signal generated by the touch sensor to a content playback apparatus as described above in a wireless manner, and operates the content playback apparatus by remote control.

It is desired to operate the content playback apparatus together with the electronic apparatus which operates the content playback apparatus by remote control, and thereby further reduce the user's trouble.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an electronic apparatus according to an embodiment.

FIG. 2 is an exemplary view showing the electronic apparatus according to an embodiment.

FIG. 3 is an exemplary view showing the electronic apparatus according to an embodiment.

FIG. 4 is an exemplary view showing the electronic apparatus according to an embodiment.

FIG. 5 is an exemplary view showing the electronic apparatus according to an embodiment.

FIG. 6 is an exemplary view showing the electronic apparatus according to an embodiment.

FIG. 7 is an exemplary view showing the electronic apparatus according to an embodiment.

FIG. 8 is an exemplary view showing the electronic apparatus according to an embodiment.

FIG. 9 is an exemplary view showing the electronic apparatus according to an embodiment.

FIG. 10 is an exemplary view showing the electronic apparatus according to an embodiment.

FIG. 11 is an exemplary view showing the electronic apparatus according to an embodiment.

### DETAILED DESCRIPTION

Various embodiments will be described hereinafter with reference to the accompanying drawings. In general, according to one embodiment, an electronic apparatus for controlling an external device comprises a communication module, an operation module, a recognition module, and a controller. The communication module is configured to communicate with the external device. The operation module is configured to display a keyboard screen of one of a plurality of types on a display, and transmit a signal to the external device based on an operation on the keyboard screen. The recognition module is configured to recognize an attribute of an input space which is selected in the external device. The controller is configured to perform control to switch a type of the keyboard screen displayed on the display based on the attribute recognized by the recognition module.

An electronic apparatus, and a control program (non-transitory computer-readable storage medium storing computer-executable instructions) for the electronic apparatus according to an embodiment will be explained in detail hereinafter, with reference to drawings.

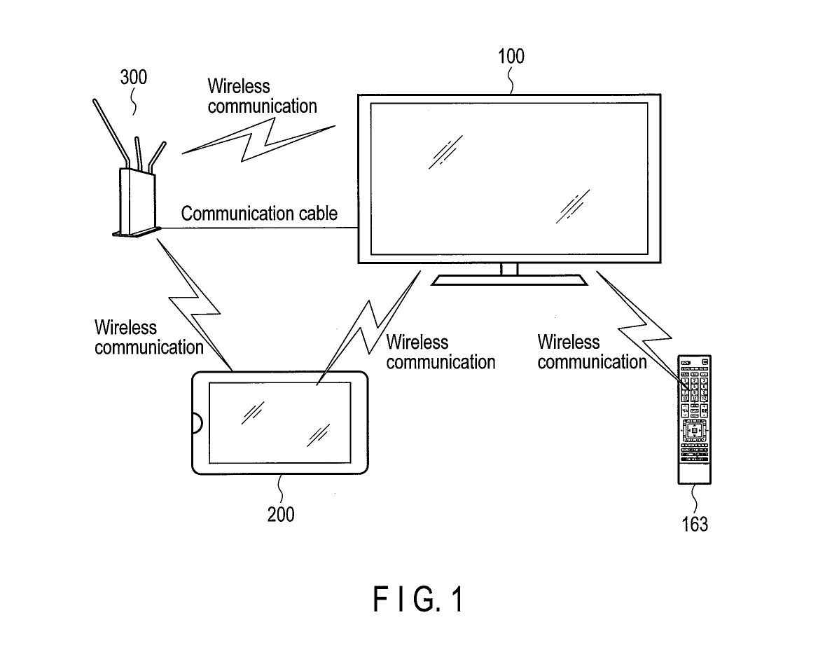

FIG. 1 is an example of a system which is formed of a plurality of electronic apparatuses. The system comprises, for example, a content playback apparatus 100, a portable apparatus 200, and a wireless communication terminal 300.

The content playback apparatus 100 is an electronic apparatus, such as a broadcasting receiver which can playback broadcasting signals or image contents stored in storage media. In the following explanation, the content playback apparatus 100 is explained as a broadcasting receiver 100. The broadcasting receiver 100 includes a remote controller 163, and a communication module which communicates with the portable apparatus 200 and the wireless communication terminal 300.

The portable apparatus 200 is an electronic apparatus which includes a display, an operation module, and a communication module. The portable apparatus 200 is, for example, a mobile phone terminal, a tablet PC, a portable music player, or another electronic apparatus.

The wireless communication terminal 300 includes a communication module which performs wireless communication with the portable apparatus 200, and the wireless communication terminal 300. For example, the wireless communication terminal 300 functions as an access point of wireless communication. Specifically, the wireless communication terminal 300 can communicate with the broadcasting receiver 100 in a wireless manner or through a communication cable such as a LAN cable.

In addition, the wireless communication terminal 300 can communicate with the portable apparatus 200 in a wireless manner. Specifically, the broadcasting receiver 100, the portable apparatus 200, and the wireless communication terminal 300 are connected through a communication protocol (such as IP) which enables bidirectional communication.

For example, each of the broadcasting receiver 100 and the portable apparatus 200 has a function of communicating with the wireless communication terminal 300 by IEEE 802.11b/g/n or the like. The broadcasting receiver 100 and the portable apparatus 200 may have a function of directly communicating with each other. Specifically, the broadcasting receiver 100 and the portable apparatus 200 can transmit and receive data through the wireless communication terminal 300 or directly.

The portable apparatus 200 can transmit a control signal to the broadcasting receiver 100 by wireless communication. Specifically, the portable apparatus 200 can function as a controller which controls the broadcasting receiver 100 (apparatus to be controlled). The apparatus to be controlled is referred to as “controlled apparatus”. The broadcasting receiver 100 (controlled apparatus) executes processing in accordance with a control signal (control command) transmitted from a controller which is a controlling device. The broadcasting receiver 100 which is a controlled apparatus transmits its current operation state to the controller. The broadcasting receiver 100 transmits its operation state at timing in accordance with an event of the controlled side or with a notification that is periodically transmitted.

For example, the portable apparatus 200 periodically performs polling for the broadcasting receiver 100 by wireless communication. Thereby, the portable apparatus 200 can recognize the state of the broadcasting receiver 100. Specifically, when the broadcasting receiver 100 receives a command relating to polling from the portable apparatus 200, the broadcasting receiver transmits information relating to connected apparatuses, information relating to the application being executed, and other information items to the portable apparatus 200 in return. Thereby, the portable apparatus 200 can recognize information relating to connected apparatuses connected to the broadcasting receiver 100, information relating to the application being executed by the broadcasting receiver 100, and other information items.

In addition, the wireless communication terminal 300 can connect to an external network. Specifically, the wireless communication terminal 300 can access the Internet in response to a request from the broadcasting receiver 100 or the portable apparatus 200, and access an address indicated by the request.

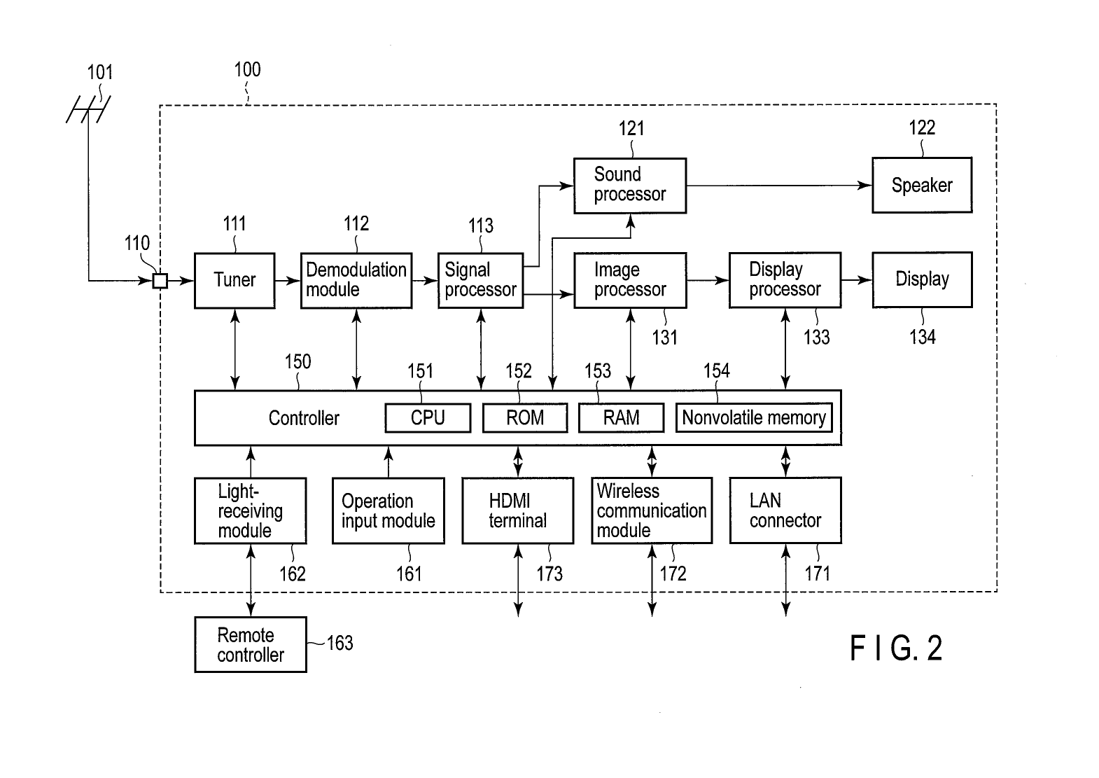

FIG. 2 illustrates an example of the broadcasting receiver 100 according to an embodiment.

The broadcasting receiver 100 includes a broadcasting signal input terminal 110, a tuner 111, a demodulation module 112, a signal processor 113, a sound processor 121, an image processor 131, a display processor 133, a controller 150, an operation input module 161, a light-receiving module 162, a LAN connector 171, a wireless communication module 172, and an HDMI terminal 173. The broadcasting receiver 100 further includes a speaker 122 and a display 134.

The broadcasting signal input terminal 110 can receive digital broadcasting signals received by, for example, an antenna 101. The antenna 101 can receive, for example, terrestrial digital broadcasting signals, BS (broadcasting satellite) digital broadcasting signals, and/or 110° CS (communication satellite) digital broadcasting signals. The broadcasting signal input terminal 110 can receive data of contents such as programs supplied by the above digital broadcasting signals.

The broadcasting signal input terminal 110 supplies the received digital broadcasting signals to the tuner 111. The tuner 111 is a tuner for digital broadcasting signals. The tuner 111 transmits the tuned digital broadcasting signal to the demodulation module 112.

The demodulation module 112 demodulates the received digital broadcasting signal. Thereby, the demodulating module 112 obtains content data such as a transport stream (TS) from the digital broadcasting signal. The demodulation module 112 inputs the obtained content data to the signal processor 113. Specifically, the antenna 101, the tuner 111, and the demodulation module 112 function as a receiving module which receives content data.

The signal processor 113 performs signal processing such as division of content data. Specifically, the signal processor 113 divides the content data into a digital image signal, a digital sound signal, and other data signals. The signal processor 113 supplies the sound signal to the sound processor 121. The signal processor 113 also supplies the image signal to the image processor 131. In addition, the signal processor 113 supplies the data signals to the controller 150.

The sound processor 121 converts the digital sound signal received from the signal processor 113 into a signal (audio signal) of a format which can be played back by the speaker 122. For example, the sound processor 121 converts the digital sound signal into an audio signal by digital/analog conversion. The sound processor 121 supplies the audio signal to the speaker 122. The speaker 122 plays back sound based on the supplied audio signal.

The image processor 131 converts the digital image signal received from the signal processor 113 into an image signal of a format which can be played back by the display 134. Specifically, the image processor 131 decodes (plays back) the digital image signal received from the signal processor module 113 into an image signal of a format which can be played back by the display 134. The image processor 131 outputs the image signal to the display processor 133.

The display processor 133 controls, for example, tone, brightness, sharpness, contrast, and other image qualities of the received image signal, based on control from the controller 150. The display processor 133 supplies the image signal which has been subjected to image quality control to the display 134. The display 134 displays an image based on the supplied image signal.

The display 134 includes, for example, a liquid crystal display device which includes a liquid crystal display panel that includes a plurality of pixels arranged in rows and columns, and a backlight that illuminates the liquid crystal display panel. The display 134 displays an image based on the image signal supplied from the display processor 133.

The controller 150 functions as a controller which controls operations of the modules of the broadcasting receiver 100. The controller 150 includes a CPU 151, a ROM 152, a RAM 153, and a nonvolatile memory 154. The controller 150 performs various processing, based on operation signals supplied from the operation input module 161.

The CPU 151 includes an arithmetic element which executes various operation processing. The CPU 151 realizes various functions by executing programs stored in the ROM 152 or the nonvolatile memory 154.

The ROM 152 stores a program for controlling the broadcasting receiver 100, and programs for realizing various functions. The CPU 151 starts the program stored in the ROM 152, based on an operation signal supplied from the operation input module 161. Thereby, the controller 150 controls operations of the modules.

The RAM 153 functions as a work memory of the CPU 151. Specifically, the RAM 153 stores operation results of the CPU 151, and data read by the CPU 151.

The nonvolatile memory 154 is a nonvolatile memory which stores various setting information items and programs.

The controller 150 can generate various displays which are superposed and displayed on the image displayed on the display 134.

The operation input module 161 includes, for example, an operation key or a touch pad, which generates an operation signal in response to operation input by the user. The operation input module 161 may have a structure of receiving an operation signal from a keyboard, a mouse, or another input device which can generate an operation signal. The operation input module 161 supplies an operation signal to the controller 150. The touch pad includes a capacitive sensor, or a device which generates position information based on another method.

The light-receiving module 162 includes, for example, a sensor which receives an operation signal from the remote controller 163. The light-receiving module 162 supplies the received signal to the controller 150. The controller 150 receives the signal supplied from the light-receiving module 162, amplifies the received signal, and performs A/D conversion for the received signal. Thereby, the controller 150 decodes the original operation signal transmitted from the remote controller 163.

The remote controller 163 generates an operation signal based on user's operation input. The remote controller 163 transmits the generated operation signal to the light-receiving module 162 by infrared data communication. The light-receiving module 162 and the remote controller 163 may transmit and receive the operation signal by another wireless communication such as radio wave communications. The detailed structure of the remote controller 163 will be described later.

The LAN connector 171 is an interface configured to perform communication with other devices on a network, such as the Internet, intranet, or home network, through a LAN. As described above, when the wireless communication terminal 300 is connected with the LAN connector 171 by a LAN cable, the broadcasting receiver 100 can communicate with another device that is connected to the wireless communication terminal 300. For example, the broadcasting receiver 100 can obtain and play back content stored in a device on a network, by the LAN connector 171. An external wireless communication device (not shown) which has a function equal to that of the wireless communication module 171 explained later may be attached to the LAN connector 171, to connect with the wireless communication terminal 300 in a wireless manner. In addition, the broadcasting receiver 100 may output the content data to a device which is connected by the LAN connector 171.

The wireless communication module 172 is an interface configured to communicate with the wireless communication terminal 300 serving as an access point through a wireless LAN. The wireless communication module 172 can communicate with other devices on the network such as the Internet, intranet, or home network, through the wireless communication terminal 300. For example, the wireless communication module 172 has a function of communicating with the wireless communication terminal 300, by IEEE 802.11b/g/n or the like.

As described above, when the wireless communication terminal 300 is connected with the wireless communication module 172 by the wireless LAN, the broadcasting receiver 100 can communicate with another device that is connected to the wireless communication terminal 300. The wireless communication module 172 may have a structure of directly communicating with another device by the wireless LAN, without through the wireless communication terminal 300.

The HDMI terminal 173 is an interface configured to perform communication based on the standard such as HDMI (High Definition Multimedia Interface) (Registered Trademark). The HDMI terminal 173 is connected with a hard disk recorder, or another device compliant with HDMI. The HDMI terminal 173 can receive content data that is outputted from the connected device. The controller 150 inputs the content data received by the HDMI terminal 173 to the signal processor 113.

The broadcasting receiver 100 may also include a storage device such as a hard disk drive (HDD), and may be configured to store contents supplied by the broadcasting signal or network in the storage device.

The broadcasting receiver 100 can start a browser configured to let the user to view various information items on the network, by executing programs or applications stored in the nonvolatile memory 154. The broadcasting receiver 100 can achieve various processing on the browser, in response to operation signals. For example, the broadcasting receiver 100 can select an item on the browser, and select a character input space, in response to operation signals.

The broadcasting receiver 100 can start a software keyboard, which causes the user to select characters on the screen and thereby can generate a character string, by executing a program or application stored in the nonvolatile memory 154. The broadcasting receiver 100 causes the user to select a button which corresponds to a character on the software keyboard, in response to an operation signal. The broadcasting receiver 100 can generate a character string in accordance with the selected buttons.

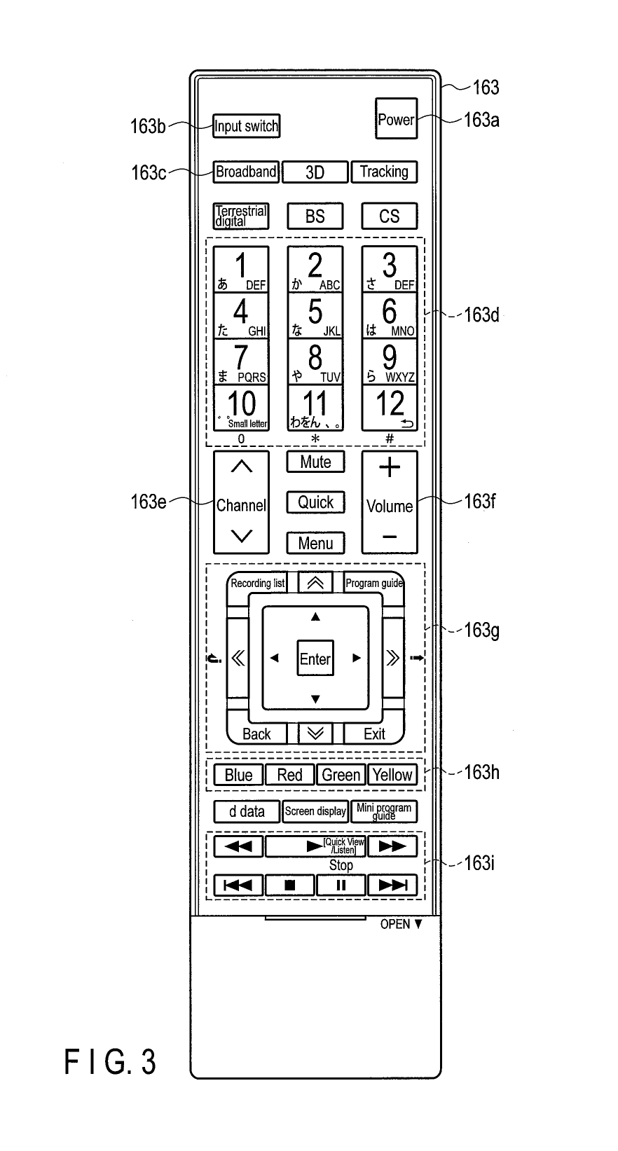

FIG. 3 illustrates an example of a structure of the remote controller 163.

The remote controller 163 includes a power supply key 163a, an input switch key 163b, function keys 163c, number keys 163d, a channel key 163e, a volume key 163f, cursor keys 163g, color keys 163h, and control keys 163i. The remote controller 163 generates operation signals in response to operations of the respective keys, and outputs the generated operation signals. For example, the remote controller 163 outputs the operation signal by infrared light.

The power supply key 163a is a key configured to cause the broadcasting receiver 100 to change the power supply state.

The input switch key 163b is a key configured to cause the broadcasting receiver 100 to switch the input terminal of the broadcasting signal and content. The broadcasting receiver 100 switches the content date to be supplied to the signal processor 113, in response to operation of the input switch key 163b.

The function keys 163c are keys configured to cause the broadcasting receiver 100 to execute various functions. The function keys 163c include, for example, a broadband key, a 3D key, and a tracking key. The broadband key is a key configured to cause the broadcasting receiver 100 to start the browser to view the Internet.

The 3D key is a key configured to cause the broadcasting receiver 100 to switch 2D display and 3D display. The tracking key is a key configured to cause the broadcasting receiver 100 to display a screen for the user's checking the position where the user can view 3D display.

The number keys 163d are keys configured to cause the broadcasting receiver 100 to select a channel. The broadcasting receiver 100 select a broadcasting signal (channel), based on an operation signal which corresponds to one of the number keys 163d. The number keys 163d also function as keys configured to input a character string.

For example, when the above browser has already been started and a character input space in the screen of the browser is selected, the broadcasting receiver 100 generates a character string based on an operation signal which corresponds to the number keys 163d, and inputs the generated character string to the character input space. The remote controller 163 also includes a selection key configured to select broadcasting signals, such as terrestrial digital broadcasting signals, BS broadcasting signals, and CS broadcasting signals.

The channel key 163e is a key configured to cause the broadcasting receiver 100 to select a channel. The volume key 163f is a key configured to cause the broadcasting receiver 100 to control the volume.

The cursor keys 163g are keys configured to cause the broadcasting receiver 100 to perform various processing. The cursor keys 163g include a cross key, an enter key, a program guide key, a recording list key, a back key, and an exit key. The broadcasting receiver 100 select various items on the screen, based on operation signals which correspond to the cross key or enter key.

In addition, the broadcasting receiver 100 switches the recording list screen, the program guide screen, and another display screen, based on an operation signal which corresponds to the back key. The broadcasting receiver 100 also ends the recording list screen, the program guide screen, and another display screen, based on an operation signal which corresponds to the exit key.

The broadcasting receiver 100 also generates a program guide screen based on the broadcasting signals, and displays the program guide screen on the display 134, based on an operation signal which corresponds to the program guide key. In addition, the broadcasting receiver 100 generates a screen (recording list screen) which shows a list (recording list) of recorded contents which can be played back by the broadcasting receiver 100, and displays the recording list screen on the display 134, based on an operation signal which corresponds to the recording list key.

When the browser is started in response to operation of the broadband key, the broadcasting receiver 100 selects an item on the browser in response to operation using the cursor keys 163g. When a character input space on the browser is selected by operation using the cursor keys 163g, the broadcasting receiver 100 starts the software keyboard. The broadcasting receiver 100 generates a character string by operation using the number keys 163d while the software keyboard operates, and inputs the generated character string to the character input space.

The color keys 163h are keys configured to cause the broadcasting receiver 100 to perform various operations.

The control keys 163i includes a play key, a stop key, a fast-forward key, a rewind key, a pause key, a next key, and a former key.

The broadcasting receiver 100 starts playback, stop, fast-forwarding, rewinding, and pause of the content, based on operation signals which correspond to the respective keys.

The remote controller 163 also includes a mute key, a quick key, a menu key, a d data key, a screen display key, and a mini program guide key.

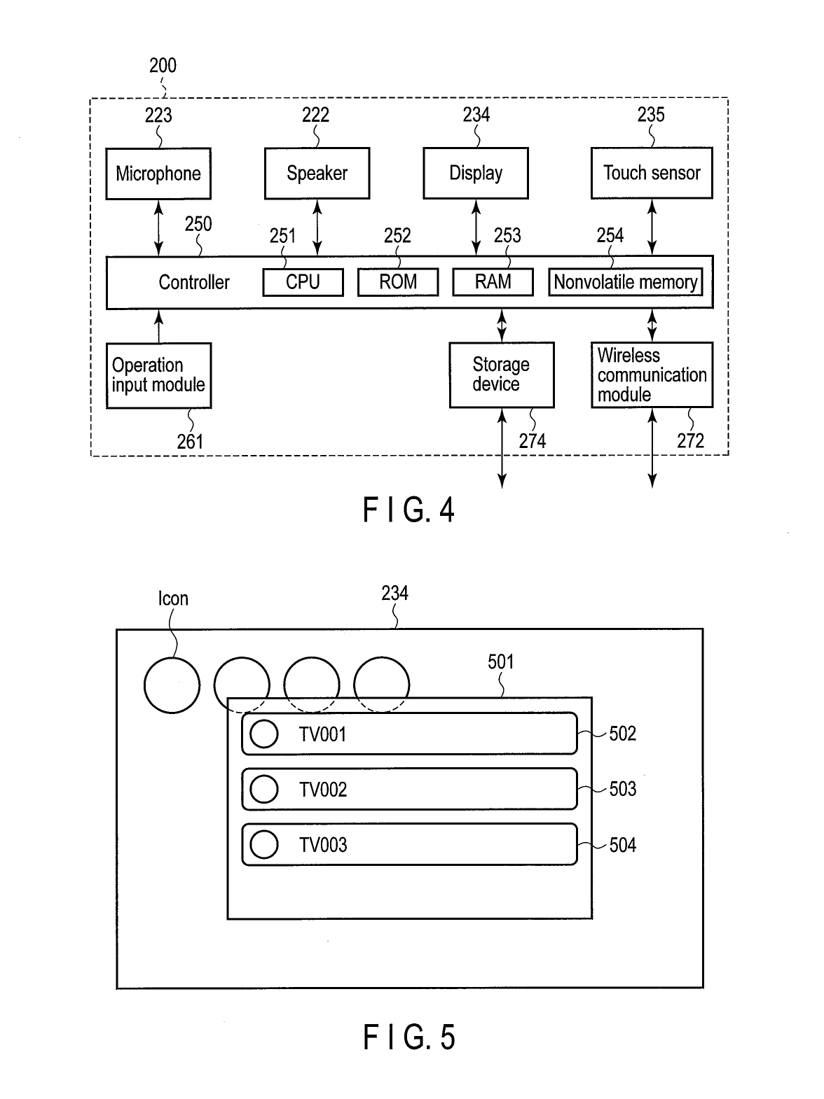

FIG. 4 illustrates an example of the portable apparatus 200 according to an embodiment.

The portable apparatus 200 includes a controller 250, an operation input module 261, a wireless communication module 272, and a storage device 274. The portable apparatus 200 further includes a speaker 222, a microphone 223, a display 234, and a touch sensor 235.

The controller 250 functions as a controller which controls operations of the modules of the portable apparatus 200. The controller 250 includes a CPU 251, a ROM 252, a RAM 253, and a nonvolatile memory 254. The controller 250 performs various processing, based on operation signals supplied from the operation input module 261 or the touch sensor 235.

The CPU 251 includes an arithmetic element which executes various operations. The CPU 251 realizes various functions by executing programs stored in the ROM 252 or the nonvolatile memory 254.

The ROM 252 stores a program configured to control the portable apparatus 200, and programs configured to realize various functions. The CPU 251 starts a program stored in the ROM 252, based on an operation signal supplied from the operation input module 261. Thereby, the controller 250 controls operations of the modules.

The RAM 253 functions as a work memory of the CPU 251. Specifically, the RAM 253 stores operation results of the CPU 251, and data read by the CPU 251.

The nonvolatile memory 254 is a nonvolatile memory which stores various setting information items and programs.

The CPU 251 can execute various processing, based on data such as applications stored in the storage device 274.

The controller 250 can also generate image signals such as various screens, in accordance with the application being executed by the CPU 251, and display them on the display 234. The controller 250 can also generates sound signals such as various sounds, in accordance with the application being executed by the CPU 251, and output them from the speaker 222.

The speaker 222 plays back sound based on the supplied audio sound.

The microphone 223 is a directional microphone which generates a signal (recording signal) based on external sound of the portable apparatus 200. The microphone 223 supplies the recording signal to the controller 250.

The display 234 includes, for example, a liquid crystal display device which includes a liquid crystal display panel that includes a plurality of pixels arranged in rows and columns, and a backlight that illuminates the liquid crystal display panel. The display 234 displays an image based on an image signal.

The touch sensor 235 is a capacitive sensor, a thermo-sensor, or a device which generates position information based on another method. For example, the touch sensor 235 is provided as one unitary piece with the display 234. Thereby, the touch sensor 235 can generate an operation signal based on operation on the screen that is displayed on the display 234, and supply the operation signal to the controller 250.

The operation input module 261 includes, for example, a key which generates an operation signal in response to operation input performed by the user. The operation input module 261 includes, for example, a volume control key configured to control the volume, a brightness control key configured to control the display brightness of the display 234, and a power supply key to switch the power supply state of the portable apparatus 200. The operation input module 261 may further include a track ball configured to cause the portable apparatus 200 to execute various selecting operations. The operation input module 261 generates operation signals in response to operation of the above keys, and supplies the operation signals to the controller 250.

The operation input module 261 may have a structure of receiving an operation signal from a keyboard, a mouse, or another input device which can generate an operation signal. For example, when the portable apparatus 200 includes a USB terminal or a Bluetooth (Registered Trademark) module, the operation input module 261 receives an operation signal from an input device which is connected through USB or Bluetooth, and supplies the operation signal to the controller 250.

The wireless communication module 272 is an interface configured to communicate with the wireless communication terminal 300 serving as an access point through a wireless LAN. The wireless communication module 272 can communicate with another apparatus on the network such as the Internet, intranet, and home network, through the wireless communication terminal 300. For example, the wireless communication module 272 has a function of communicating with the wireless communication terminal 300 by IEEE 802.11b/g/n.

As described above, when the wireless communication terminal 300 is connected with the wireless communication module 272 through the wireless LAN, the portable apparatus 200 can communicate with another apparatus that is connected to the wireless communication terminal 300. The wireless communication module 272 may have a structure of directly communicating with another apparatus through the wireless LAN, without through the wireless communication terminal 300.

The portable apparatus 200 also includes a power supply module (not shown). The power supply module includes a battery, and a terminal (such as DC jack) configured to be connected to an adaptor that receives electric power from a commercial power supply or the like. The power supply module charges the battery with the electric power received from the commercial power supply. The power supply module supplies the electric power of the battery to the modules in the portable apparatus 200.

The storage device 274 includes a hard disk drive (HDD), a solid-state drive (SSD), or a semiconductor memory. The storage device 274 can store programs and applications executed by the CPU 251 of the controller 250, and various data.

The storage device 274 stores, for example, an operating system (OS), and various applications which can be executed on the OS. The storage device 274 stores, for example, a browsing application (browser application), a remote control application (remote controller application), a character input application (keyboard application), a pointing application, and sound input application (sound input application).

The browser application is a browser to view the Internet. The remote controller application is a program configured to cause the portable apparatus 200 to function as a controller of another apparatus. The keyboard application is a program configured to facilitate character input performed with the touch sensor 235. The pointing application is a program configured to facilitate pointing operation performed with the touch sensor 235. The sound input application is a program configured to generate a character string based on a recording signal obtained by the microphone 223.

The keyboard application, the pointing application, and the sound input application may be included in the remote controller application as part of the function of the remote controller application.

FIG. 5 illustrates an example of a home screen of the OS, which is displayed on the display 234 of the portable apparatus 200. Icons configured to start various applications are displayed in the home screen. When the remote controller application is selected on the home screen or from a list of applications, the controller 250 of the portable apparatus 200 starts the remote controller application.

When the remote controller application is started, the controller 250 displays a window 501 to select an apparatus to be controlled by the remote controller application on the display 234. The controller 250 displays, in the window 501, a list of apparatuses (controlled apparatuses) which are registered in advance as apparatuses to be controlled by the remote controller application.

For example, when apparatuses “TV001”, “TV002”, and “TV003” are registered, the controller 250 displays a button 502 to select “TV001”, a button 503 to select “TV002”, and a button 504 to select “TV003” in the window 501.

When one of the above buttons is selected, the controller 250 displays a screen (remote controller screen) to control the selected apparatus on the display 234.

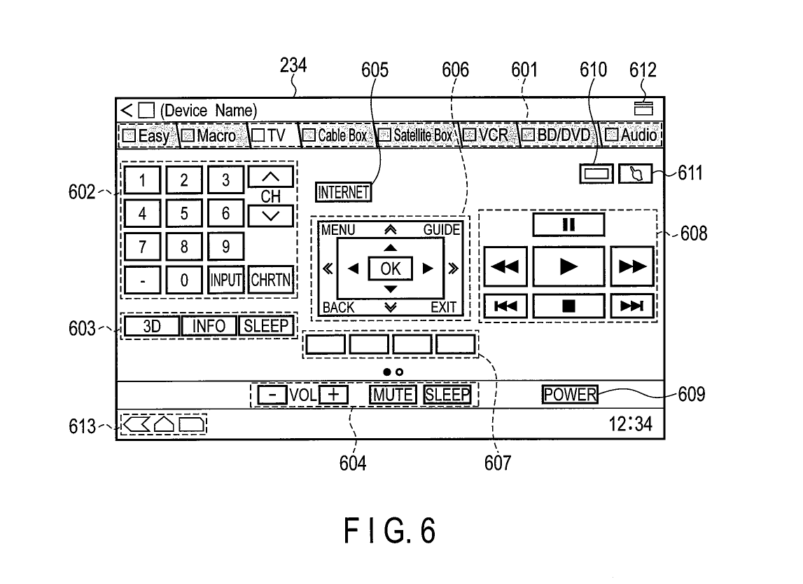

FIG. 6 illustrates an example of the remote controller screen. In the present embodiment, FIG. 6 illustrates an example of a remote controller screen to control the broadcasting receiver 100. The controller 250 displays a remote controller screen on the display 234. The controller 250 transmits a signal to the broadcasting receiver 100 which is a controlled apparatus, in response to operation on the remote controller screen.

The controller 250 displays an apparatus selection tab 601, channel selection buttons 602, function buttons 603, volume buttons 604, an Internet button 605, cursor buttons 606, color buttons 607, controller buttons 608, a power supply button 609, a keyboard button 610, a pointer button 611, a setting button 612, and a menu button 613 in the remote controller screen.

The portable apparatus 200 generates operation signals in response to operations of the respective buttons, and outputs the generated operation signals. For example, the portable apparatus 200 transmits an operation signal by the wireless communication module 272 to the broadcasting receiver 100 through a wireless LAN or the like.

The apparatus selection tab 601 is a tab to select an apparatus to be controlled by the remote controller application.

The channel selection buttons 602 are keys to cause the broadcasting receiver 100 to perform channel selection. The channel selection buttons 602 include a plurality of number buttons and up and down buttons. The broadcasting receiver 100 performs selection of a broadcasting signal (selects a channel), based on an operation signal which corresponds to the channel selection button 602.

The function buttons 603 are keys to cause the broadcasting receiver 100 to execute various functions. The function buttons 603 include, for example, a 3D button, an information button, and a sleep button.

The 3D button is a key to cause the broadcasting receiver 100 to switch 2D display with 3D display. The information button is a key to cause the broadcasting receiver 100 to display various information items. For example, the broadcasting receiver 100 displays information relating to the content, and a screen based on various data included in the broadcasting signal on the display 134, based on the operation signal which corresponds to the information button. The sleep button is a button to perform setting relating to power supply control of the broadcasting receiver 100.

The volume buttons 604 are buttons to cause the broadcasting receiver 100 to control the volume. The volume buttons 604 includes a plus button and a minus button. The broadcasting receiver 100 controls the volume of the speaker 122, based on operation signals which correspond to the plus button and the minus button.

The volume buttons 604 also include a mute button. The broadcasting receiver 100 is switched to a mute state in which no sound is outputted from the speaker 122, based on an operation signal which corresponds to the mute button.

The Internet button 605 is a button to cause the broadcasting receiver 100 to start the browser to view the Internet. The broadcasting receiver 100 starts the browser, based on an operation signal which corresponds to the Internet button 605.

The cursor buttons 606 are buttons to cause the broadcasting receiver 100 to execute various processing. The cursor buttons 606 include a cross button, an enter button (OK button), a program guide button (guide button), a menu button, a back button, and an end button (exit button). The broadcasting receiver 100 performs selection of various items on the screen, in response to operation signals which correspond to the cross button and the enter button.

The broadcasting receiver 100 also switches the recording list screen, the program guide screen, and other display screens, based on an operation signal which corresponds to the back button. The broadcasting receiver 100 also ends display of the recording list screen, the program guide screen, and other display screens, based on an operation signal which corresponds to the exit button.

In addition, the broadcasting receiver 100 generates a program guide screen based on broadcasting signals, and displays the program guide screen on the display 134, based on an operation signal which corresponds to the program guide button. Besides, the broadcasting receiver 100 displays a menu to change various settings of the broadcasting receiver 100 on the display 134, based on an operation signal which corresponds to the menu button.

The color buttons 607 are buttons configured to cause the broadcasting receiver 100 to perform various operations.

The control buttons 608 include a play button, a stop button, a fast-forward button, a rewind button, a pause button, a next button, and a former button.

The broadcasting receiver 100 starts playback, stop, fast-forwarding, and rewinding of the content, based on operation signals which correspond to the respective buttons.

The power button 609 is a button to cause the broadcasting receiver 100 to switch its power supply state.

The keyboard button 610 is a button configured to cause the portable apparatus 200 to start the keyboard screen. The pointer button 611 is a button configured to cause the portable apparatus 200 to start the pointer screen. The keyboard screen will be explained later.

The setting button 612 is a button to display a setting menu for changing various settings of the remote controller application. The portable apparatus 200 displays the setting menu on the display 234, in response to operation of the setting button 612.

The menu buttons 613 are buttons configured to cause the portable apparatus 200 to execute various operations on the OS. The menu buttons 613 include a back button, and a home button and the like. The portable apparatus 200 switches the screen of the application which is being executed to the previous screen, in response to operation of the back button. The portable apparatus 200 displays the home screen of the OS on the display 234, in response to operation of the home button.

The pointer screen is a screen to generate an operation signal, based on a locus of operation by the user. The controller 250 detects position information by the touch sensor 235, in response to operation on the input space displayed on the display 234. Thereby, the controller 250 can detect a locus (gesture) of operation in the input space. The controller 250 generates an operation signal based on the detected gesture, and transmits the generated operation signal to the broadcasting receiver 100 which is the controlled apparatus.

The broadcasting receiver 100 operates the pointer, in response to the operation signal received from the portable apparatus 200. Specifically, the portable apparatus 200 can control operation of the pointer and other operations of the broadcasting receiver 100, in response to operation on the pointer screen. Thereby, the portable apparatus 200 can control operation of the browser of the broadcasting receiver 100, in accordance with operation on the pointer screen.

The portable apparatus 200 performs polling with the broadcasting receiver 100 which is the controlled apparatus, at predetermined intervals. Thereby, the portable apparatus 200 can recognize that the browser was started in the broadcasting receiver 100. When the browser is started in the broadcasting receiver 100, the portable apparatus 200 starts the pointing application.

The broadcasting receiver 100 may have a structure of transmitting a command that the browser was started to the portable apparatus 200, when the browser is started. In this case, the portable apparatus 200 starts the pointing application, when the portable apparatus 200 receives the command from the broadcasting receiver 100.

As described above, when the Internet button 605 of the remote controller screen is operated, the portable apparatus 200 transmits an operation signal to the broadcasting receiver 100, to cause the broadcasting receiver 100 to start the browser to view the Internet. The portable apparatus 200 may have a structure of starting the pointing application when the Internet button 605 is operated.

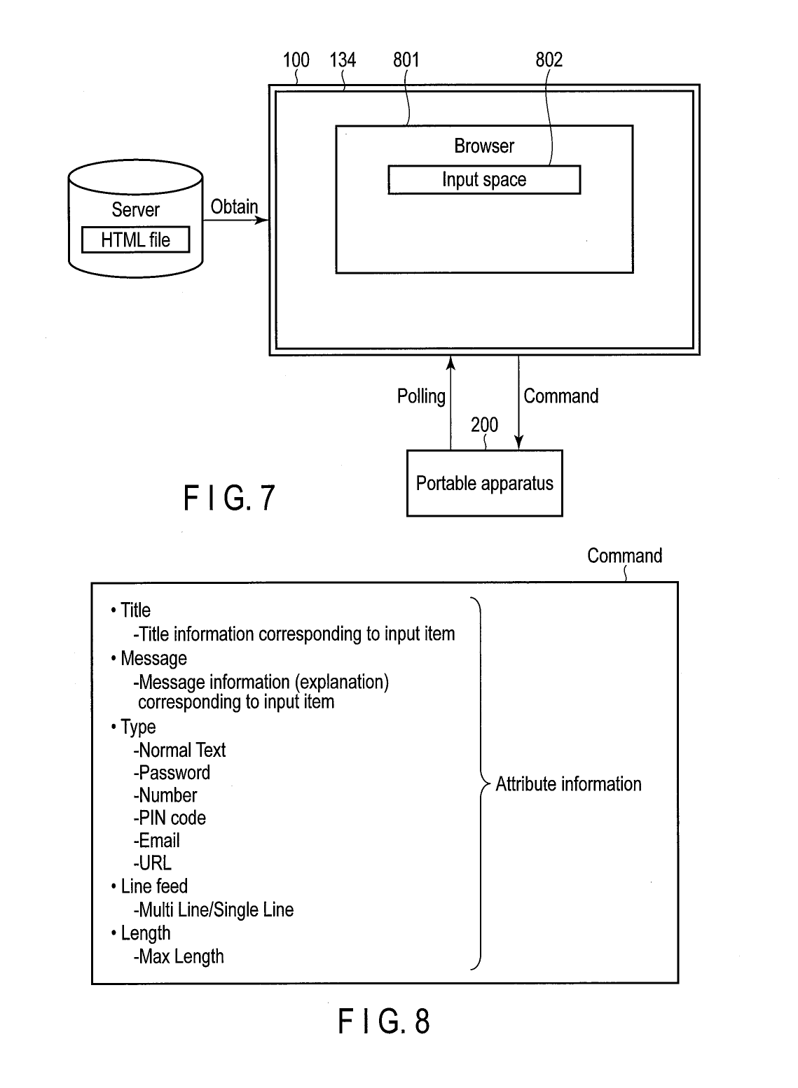

FIG. 7 illustrates an example of display of the browser which is started on the broadcasting receiver 100.

As described above, the broadcasting receiver 100 starts the browser, by executing a program or application stored in the nonvolatile memory 154 in response to user's operation. The broadcasting receiver 100 generates an image to display the window 801 of the browser on the display 134.

The controller 150 of the broadcasting receiver 100 accesses an html file which is stored in a server on the Internet. The controller 150 obtains the html file from the server, performs rendering by the browser, and displays the html file on the display 134. Thereby, for example, the broadcasting receiver 100 can select an item on the browser, and select a character input space, in response to operation signals.

Suppose that the html file includes an input space 802 as illustrated in FIG. 7. When the input space 802 is selected, the controller 150 of the broadcasting receiver 100 transmits a command to display the keyboard screen to the portable apparatus 200. In this case, the controller 150 obtains attribute information which indicates various attributes of the input space 802 from the html file, and adds the obtained attribute information to the command. The controller 150 transmits the command, to which the attribute information has been added, to the portable apparatus 200.

The attribute information of the input space 802 is, for example, information which indicates at least one of “text (Normal Text)”, “password”, “number”, “E-mail address”, “URL”, “PIN code”, and another type of information. The attribute information of the input space 802 indicates the type of the input space 802 as described above, “possibility of Line feed (Multi Line/Single Line)”, and “limitations to number of characters (maximum length)”. The items “Multi Line/Single Line” and “Maximum length” may be omitted. These attribute information items are embedded as tags in the html file. The controller 150 extracts the attribute information of the input space 802 from the html file.

The controller 150 may have a structure of extracting attribute information which is included in a BML file, Flash file, or another file, not an html file, and indicates the type of the input space from the file. The controller 150 may use a predetermined type as the type of the input space.

FIG. 8 illustrates an example of a command which is transmitted from the broadcasting receiver 100 to the portable apparatus 200. As illustrated in FIG. 8, the command includes title information which indicates a title that corresponds to the input space, message information which indicates an explanation that corresponds to the input space, type information which indicates the type of the input space, line feed information which indicates whether line feed is possible or not, and length information which indicates the maximum number of characters.

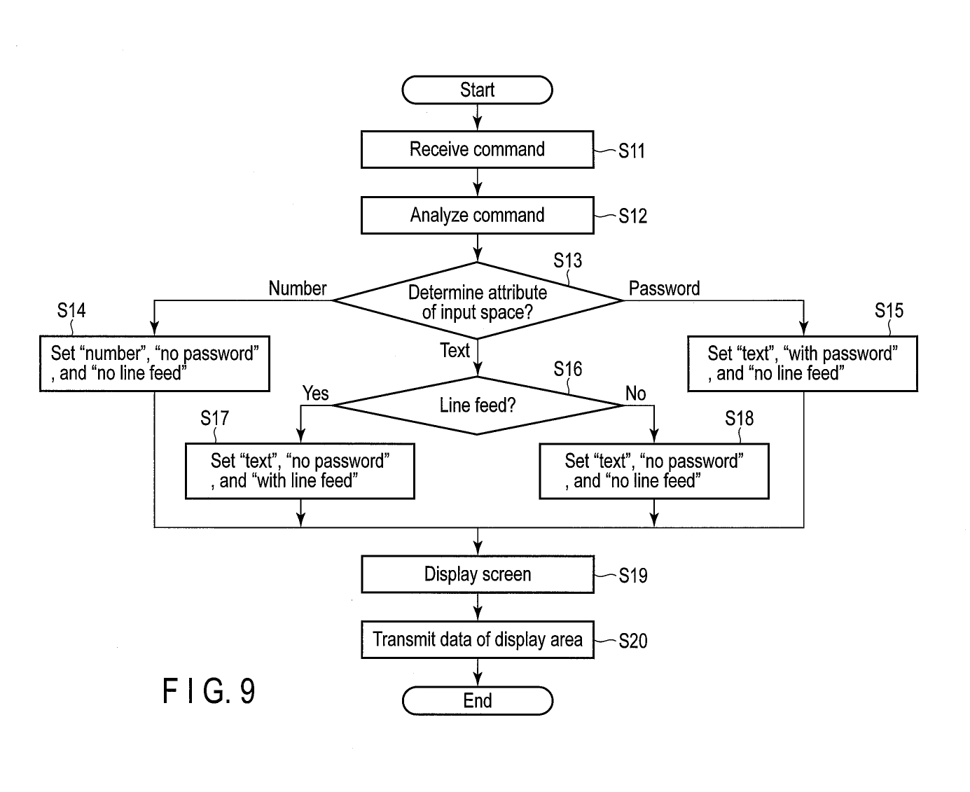

FIG. 9 illustrates an example of processing performed by the portable apparatus 200.

The controller 250 of the portable apparatus 200 receives a command transmitted from the broadcasting receiver 100 (Step S11). The controller 250 analyzes the received command (Step S12). Thereby, the controller 250 can recognize that the input space was selected in the broadcasting receiver 100. In addition, the controller 250 can analyze the command, and thereby extract the type information which indicates the type of the input space, the line feed information which indicates whether line feed is possible or not, and the length information which indicates the maximum number of characters.

The controller 250 determines the type of the input space based on the extracted type information (Step S13). Thereby, the controller 250 determines which of “normal text”, “password”, “number”, “Email address”, “URL” and “PIN code” is to be inputted to the input space. The controller 250 also sets parameters for displaying the keyboard screen, in accordance with the determination result. For example, the controller 250 sets the parameters in the RAM 253. The controller 250 selects the type of the input space in the keyboard screen and the type of the software keyboard, in accordance with the set parameters, and generates the keyboard screen.

The controller 250 sets parameters in accordance with the type of the input space. In the present example, suppose that the controller 250 has a structure of determining which of “text”, “password”, and “number” is to be inputted to the input space. The types of the input space identified by the controller 250 may be added, if necessary.

When the type is “number”, the controller 250 sets information items such as “text”, “no password display”, and “no line feed” as parameters (Step S14), and goes to Step S19.

When the type is “password”, the controller 250 sets information items such as “text”, “with password display”, and “no line feed” as parameters (Step S15), and goes to Step S19.

When the type is “text”, the controller 250 determines whether line feed is possible or not, based on the line feed information in the command (Step S16).

When it is determined at Step S16 that line feed is possible, the controller 250 sets information items such as “text”, “no password display”, and “with line feed” as parameters (Step S17), and goes to Step S19.

When it is determined at Step S16 that line feed is impossible, the controller 250 sets information items such as “text”, “no password display”, and “no line feed” as parameters (Step S18), and goes to Step S19.

The controller 250 generates the keyboard screen based on the set parameters, and displays the keyboard screen on the display 234 (Step S19).

Furthermore, the controller 250 transmits information input in the input space of the keyboard screen to the broadcasting receiver 100 based on the operation input (Step S20).

When the item “text” is set as a parameter, the controller 250 generates a keyboard screen which includes a keyboard that includes character input keys. When the item “number” is set as a parameter, the controller 250 generates a keyboard screen which includes a keyboard that includes ten keys to input numbers.

When the item “with line feed” is set as a parameter, the controller 250 generates a keyboard screen which includes an input space in which line feed is possible. When the item “no line feed” is set as a parameter, the controller 250 generates a keyboard screen which includes an input space in which line feed is impossible.

When the item “with password display” is set as a parameter, the controller 250 replaces the characters which are inputted to the input space with other characters (such as “*”), and displays the other characters. When the item “no password display” is set as a parameter, the controller 250 displays the characters which are inputted to the input space, without any change.

The controller 250 can generate a plurality of types of keyboard screens, by the attributes used in combination as described above. Specifically, the controller 250 can select the type of the keyboard screen, based on the determined attributes. The controller 250 generates a keyboard screen of the selected type.

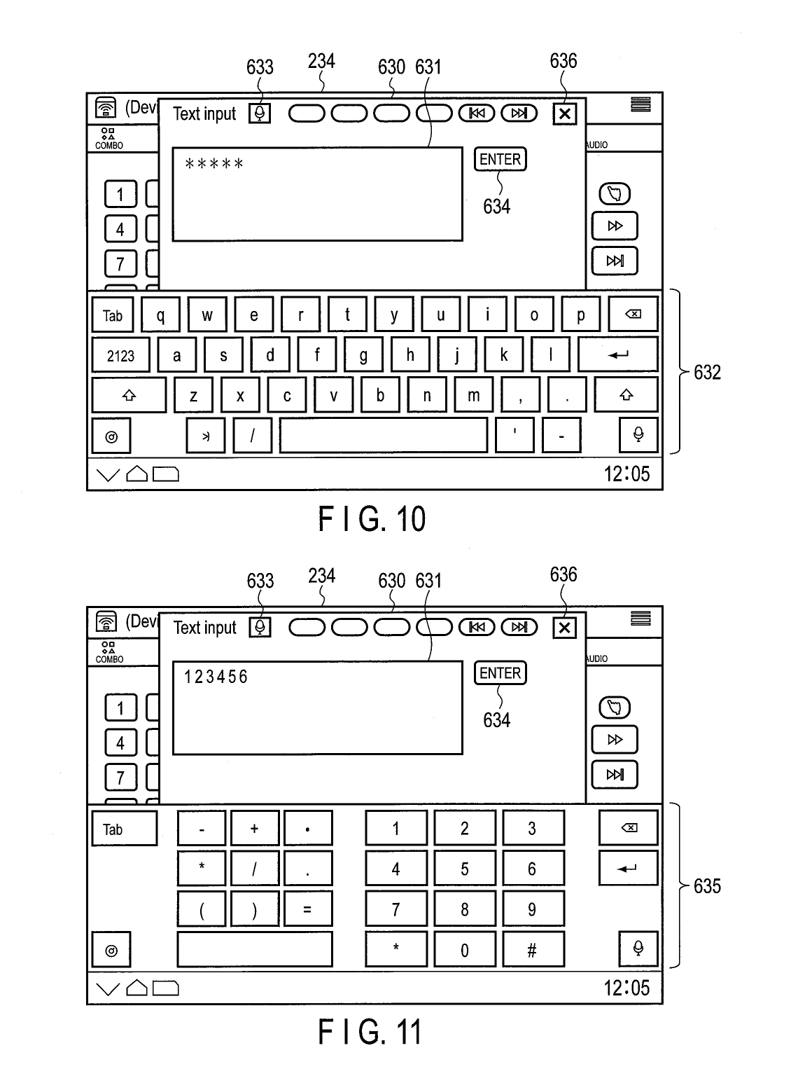

For example, when the items “text”, “with password display”, and “no line feed” are set as parameters, the controller 250 generates a keyboard screen as illustrated in FIG. 10.

FIG. 10 illustrates an example of the keyboard screen. As described above, when the input space is selected in the broadcasting receiver 100, the controller 250 generates a keyboard screen.

The controller 250 displays a display area 631, character buttons 632, a sound input button 633, a transmission button 634, and a close button 636 on the keyboard screen.

The display area 631 is a space in which a character string which is inputted by the character buttons 632 or sound input is displayed. In the display area 631, line feed is limited. In addition, since the item “with password display” is set as a parameter for the display area 631, the inputted characters are replaced with different characters (such as “*”) and the different characters are displayed.

The character buttons 632 are buttons in which a plurality of buttons that correspond to respective keys of the keyboard are arranged. The controller 250 generates a character string in response to operation of the character buttons 632. For example, the character buttons 632 include character buttons that are arranged with the Qwerty layout. The character buttons 632 may include buttons which correspond to kana input.

The sound input button 633 is a button configured to cause the portable apparatus 200 to execute the sound input function. The controller 250 generates a character string based on the recording signal obtained by the microphone 223, in response to operation of the sound input button 633.

The transmission button 634 is a button to transmit the character string that is displayed in the display area 631 to the broadcasting receiver 100. The controller 250 transmits the character string that is displayed in the display area 631 to broadcasting receiver 100, in response to operation of the transmission button 634. When the character input space is not selected in the broadcasting receiver 100, the controller 250 displays, on the display 234, information to notify the user of the portable apparatus 200 that no character string can be transmitted.

The close button 636 is a button to end the keyboard screen. The controller 250 ends the keyboard screen in response to operation of the close button 636. In this case, the controller 250 returns the screen on the display 234 to the pointer screen or the remote controller screen.

In addition, for example, when the parameters “number”, “no password display”, and “no line feed” are set, the controller 250 generates a keyboard screen illustrated in FIG. 11.

FIG. 11 illustrates an example of the keyboard screen. As described above, when the input space is selected in the broadcasting receiver 100, the controller 250 generates a keyboard screen.

The controller 250 displays the display area 631, number buttons (ten keys) 635, the sound input button 633, the transmission button 634, and the close button 636 in the keyboard screen.

The display area 631 is a space in which a character string that is inputted by the number buttons 635 or sound input is displayed. In the display area 631, line feed is limited. In addition, since the item “no password display” is set as a parameter for the display area 631, the inputted characters “12345” are displayed without any change.

The number buttons 635 are buttons in which a plurality of buttons that correspond to the ten keys of the keyboard are arranged. The controller 250 generates a character string such as numbers, in response to operation of the number buttons 635.

The controller 250 may limit the number of characters which can be inputted to the display area 631, based on the length information which indicates the maximum number of characters and is included in the command transmitted from the broadcasting receiver 100.

As described above, the controller 250 of the portable apparatus 200 determines whether any input space is selected or not in the broadcasting receiver 100, in accordance with the recognition result of the operation state of the broadcasting receiver 100. The controller 250 also determines attributes such as the type of the input space, the possibility of line feed, and presence/absence of the password. The controller 250 selects the type of the keyboard screen, in accordance with the determined attributes. The controller 250 generates the keyboard screen of the selected type.

Thereby, the portable apparatus 200 can generate a keyboard screen which is suitable for the input space that is selected in the broadcasting receiver 100 serving as the controlled apparatus, and display the keyboard screen on the display 234. Thereby, the portable apparatus 200 can cause the user to input a character string or numbers by easier operation.

When the password input space is selected in the broadcasting receiver 100 serving as the controlled apparatus, the portable apparatus 200 generates a keyboard screen which includes the display area 631 in which the inputted character string is replaced with different characters, and displays the keyboard screen on the display 234. Thereby, the portable apparatus 200 can prevent the character string which corresponds to the inputted password from being directly displayed on the display 234. As a result, the portable apparatus 200 can cause the user to input the password in a state of higher security. Consequently, it is possible to provide an electronic apparatus of higher convenience, and a control program of the electronic apparatus.

The controller 250 may have a structure of inputting the character string, which has already been inputted to the input space of the browser of the broadcasting receiver 100, to the display area 631 of FIG. 10 and FIG. 11, when the keyboard screen is started. This structure prevents overlapping input operations. In addition, the controller 250 may have the structure of successively displaying the character string inputted to the display area 631 in the input space of the browser of the broadcasting receiver 100.

Functions described in the above embodiment may be constituted not only with use of hardware but also with use of software, for example, by making a computer read a program which describes the functions and/or logic. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus for controlling an external device, comprising:
a communication module configured to communicate with the external device;
an operation module configured to display a keyboard screen of one of a plurality of types on a display, and transmit a signal to the external device based on an operation on the keyboard screen;
a recognition module configured to recognize an attribute of an input space which is selected in the external device; and
a controller configured to perform control to switch a type of the keyboard screen displayed on the display based on the attribute recognized by the recognition module.

2. The electronic apparatus of claim 1, wherein
the recognition module recognizes whether the input space selected in the external device is a password input space, and
the controller controls the operation module to display a keyboard screen, which includes a display area in which an input character is replaced with another character, on the display, if the input space selected in the external device is the password input space.

3. The electronic apparatus of claim 1, wherein
the recognition module recognizes whether the input space selected in the external device is a character input space or a number input space, and
the controller selects a keyboard screen which includes character input buttons if the input space is the character input space, the controller selects a keyboard screen which includes number input buttons if the input space is the number input space, and the controller controls the operation module to display the selected keyboard screen on the display module.

4. The electronic apparatus of claim 1, wherein
the recognition module recognizes whether the input space selected in the external device allows line feed or not, and
the controller controls the operation module to display a keyboard screen which includes a display area that limits line feed on the display module, if the input space selected in the external device does not allow line feed.

5. The electronic apparatus of claim 1, wherein
the recognition module recognizes whether the input space selected in the external device limits characters in number, and
the controller controls the operation module to display, on the display module, a keyboard screen which includes a display area that limits imputable characters in number, if the input space selected in the external device limits characters in number.

6. An electronic apparatus which operates by control from an external device, comprising:
a communication module configured to communicate with the external device;
a reception module configured to receive an operation signal to operate the electronic apparatus;
a recognition module configured to recognize an attribute of an input space selected in the electronic apparatus; and
a controller configured to transmit a recognition result obtained by the recognition module to the external device.

7. A non-transitory computer-readable storage medium storing computer-executable instructions that, when executed, cause the computer to:
communicate with an external device;
display a keyboard screen of one of a plurality of types on a display, and transmit a signal to the external device based on an operation on the keyboard screen;
recognize an attribute of an input space which is selected in the external device; and
perform control to switch a type of the keyboard screen displayed on the display based on the recognized attribute.

8. The non-transitory computer-readable storage medium of claim 7, the computer-executable instructions cause the computer to:
recognize whether the input space selected in the external device is a password input space, and
display the keyboard screen, which includes a display area in which an input character is replaced with another character, on a display, if an input space selected in the external device is a password input space.

9. The non-transitory computer-readable storage medium of claim 7, the computer-executable instructions cause the computer to:
recognize whether the input space selected in the external device is a character input space or a number input space, and
select a keyboard screen which includes character input buttons if the input space is a character input space,
select a keyboard screen which includes number input buttons if the input space is a number input space, and
control to display the selected keyboard screen on the display.

10. The non-transitory computer-readable storage medium of claim 7, the computer-executable instructions cause the computer to:
recognize whether the input space selected in the external device allows line feed or not, and
control to display a keyboard screen which includes a display area that limits line feed on the display, if the input space selected in the external device does not allow line feed.

11. The non-transitory computer-readable storage medium of claim 7, the computer-executable instructions cause the computer to:
recognize whether the input space selected in the external device limits characters in number, and
control to display a keyboard screen which includes a display area that limits imputable characters in number, if the input space selected in the external device limits characters in number.

12. A method for controlling an external device by an electronic apparatus, comprising:
communicating with the external device;
displaying a keyboard screen of one of a plurality of types on a display, and transmitting a signal to the external device based on an operation on the keyboard screen;
recognizing an attribute of an input space which is selected in the external device; and
performing control to switch a type of the keyboard screen displayed on the display based on the attribute recognized by the recognition module.

13. The method for controlling an external device of claim 12, wherein
recognizing whether the input space selected in the external device is a password input space, and
displaying a keyboard screen, which includes a display area in which an input character is replaced with another character, on the display, if the input space selected in the external device is the password input space.

14. The method for controlling an external device of claim 12, wherein
recognizing whether the input space selected in the external device is a character input space or a number input space, and
selecting a keyboard screen which includes character input buttons if the input space is the character input space,
selecting a keyboard screen which includes number input buttons if the input space is the number input space, and
controlling the operation module to display the selected keyboard screen on the display module.

15. The method for controlling an external device of claim 12, wherein
recognizing whether the input space selected in the external device allows line feed or not, and
controlling the operation module to display a keyboard screen which includes a display area that limits line feed on the display module, if the input space selected in the external device does not allow line feed.

16. The method for controlling an external device of claim 12, wherein
recognizing whether the input space selected in the external device limits characters in number, and
controlling to display a keyboard screen which includes a display area that limits imputable characters in number, if the input space selected in the external device limits characters in number.
